(19) United States
(12) Patent Application Publication
(10) Pub. No.: US 2005/0010892 A1
(43) Pub. Date: Jan. 13, 2005

(54) Method and system for integrating multi-modal data capture device inputs with multi-modal output capabilities

(75) Inventors: Arthur Eugene McNair, Pittsburgh, PA (US); Roger Graham Byford, Apollo, PA (US); Richard Anthony Bates, Pittsburgh, PA (US)

Correspondence Address: WOOD, HERRON & EVANS, LLP, 2700 CAREW TOWER, 441 VINE STREET, CINCINNATI, OH, 45202, US

(73) Assignee: Vocollect, Inc.

(21) Appl. No.: 10/617,422

(22) Filed: Jul. 11, 2003

(51) Int. Cl. G06F 9/44

(52) U.S. Cl. 717/101; 717/104; 717/100

(57) ABSTRACT

A dialog engine includes methods for integrating multi-modal data capture device inputs with multimodal output capabilities in which a work flow description is extracted from objects in a graphical user interface and a multi-modal user interface is defined. The dialog engine synchronizes the flow of information, in accordance with the work flow description, between input/output devices and an application.

### RELATED APPLICATIONS

This application is related to application Ser. No. ______ filed Jul. 11, 2003, entitled METHOD AND SYSTEM FOR INTELLIGENT PROMPT CONTROL IN A MULTI MODAL SOFTWARE APPLICATION, and is incorporated herein by reference in its entirety.

### TECHNICAL FIELD

The invention relates to multi-modal software applications and, more particularly to coordinating multi-modal input from a variety of peripheral devices with multi-modal output from additional peripheral devices.

### BACKGROUND ART

Speech recognition has simplified many tasks in the workplace by permitting hands-free communication with a computer as a convenient alternative to communication via conventional peripheral input/output devices. A worker may enter data by voice using a speech recognizer and commands or instructions may be communicated to the worker by a speech synthesizer. Speech recognition finds particular application in mobile computing devices in which interaction with the computer by conventional peripheral input/output devices is restricted.

For example, wireless wearable terminals can provide a worker performing work-related tasks with desirable computing and data-processing functions while offering the worker enhanced mobility within the workplace. One particular area in which workers rely heavily on such wireless wearable terminals is inventory management. Inventory-driven industries rely on computerized inventory management systems for performing various diverse tasks, such as food and retail product distribution, manufacturing, and quality control. An overall integrated management system involves a combination of a central computer system for tracking and management, and the people who use and interface with the computer system in the form of order fillers, pickers and other workers. The workers handle the manual aspects of the integrated management system under the command and control of information transmitted from the central computer system to the wireless wearable terminal.

As the workers complete their assigned tasks, a bidirectional communication stream of information is exchanged over a wireless network between wireless wearable terminals and the central computer system. Information received by each wireless wearable terminal from the central computer system is translated into voice instructions or text commands for the corresponding worker. Typically, the worker wears a headset coupled with the wearable device that has a microphone for voice data entry and an ear speaker for audio output feedback. Responses from the worker are input into the wireless wearable terminal by the headset microphone and communicated from the wireless wearable terminal to the central computer system. Through the headset microphone, workers may pose questions, report the progress in accomplishing their assigned tasks, and report working conditions, such as inventory shortages. Using such wireless wearable terminals, workers may perform assigned tasks virtually hands-free without equipment to juggle or paperwork to carry around. Because manual data entry is eliminated or, at the least, reduced, workers can perform their tasks faster, more accurately, and more productively.

An illustrative example of a set of worker tasks suitable for a wireless wearable terminal with voice capabilities may involve initially welcoming the worker to the computerized inventory management system and defining a particular task or order, for example, filling a load for a particular truck scheduled to depart from a warehouse. The worker may then answer with a particular area (e.g., freezer) that they will be working in for that order. The system then vocally directs the worker to a particular aisle and bin to pick a particular quantity of an item. The worker then vocally confirms a location and the number of picked items. The system may then direct the worker to a loading dock or bay for a particular truck to receive the order. As may be appreciated, the specific communications exchanged between the wireless wearable terminal and the central computer system can be task-specific and highly variable.

In addition to voice input and audio output, coordinating the concurrent and alternative interfacing with other input and output devices such as radio-frequency ID readers, bar code scanners, printers, etc. would be useful within the wireless terminal environment as well as outside this particular environment. Conventional operational software for computer platforms does not successfully accomplish this coordination among voice data entry, audio output feedback and peripheral device input.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 is a block diagram illustrating the principal hardware and software components in a developer computer capable of creating a voice-enabled application in a manner consistent with the invention and a wireless wearable terminal capable of running the voice-enabled application;

FIG. 2A is a block diagram depicting functional elements of an exemplary multi-modal application development system;

FIG. 2B is a block diagram depicting functional elements of an exemplary multi-modal application execution environment;

FIG. 3 is a block diagram showing a main display screen of the wearable computing device;

FIG. 4 is a flowchart illustrating the pre-processing of GUI objects to create a set of work flow description objects; and

FIG. 5 is a flowchart illustrating the actions taken by the dialog engine in response to receiving input from an input device.

### DETAILED DESCRIPTION OF SPECIFIC EMBODIMENTS

Aspects and embodiments of the present invention relate to creating and executing applications that expand the ability of multimodal capable computing platforms by coordinating voice data entry, audio feedback, and peripheral device input and output.

In addition to audio headsets, other peripheral devices can be coupled to the computer platform depending upon the type of tasks to be performed by a user. For example, bar code readers and other scanners may be utilized alone or in combination with the headset to communicate back and forth with a central computer system. In particular, a wireless wearable terminal can be interfaced with additional peripherals, such as a touch screen, pen display and/or a keypad, with which the user can communicate with the central computer system. According to one aspect of the present invention, a software application running on the wireless wearable platform is enabled to receive input from any of the peripheral devices for a particular data element and is also enabled to output prompts and other messages to a variety of the peripheral devices concurrently.

In particular embodiments, operational software running on the wireless wearable terminal, or other types of computing platforms, controls interactions with the peripheral devices, implements the features and capabilities of a dialog engine for speech recognition and synthesis, and controls exchanges of information with the central computer system. The operational software permits data entry from other peripheral devices associated with the wearable device and coordinates the information input and collected from those peripheral devices. Preferably, the operational software permits the worker to enter data with a peripheral device while also using voice data entry and audio output feedback such that the data from the peripheral device can be interpreted in real time with all the same capabilities as if the data were entered by voice or keyboard.

One aspect of the present invention relates to a system for executing a multimodal software application. This system includes the multimodal software application, wherein the multimodal software application is configured to receive first data input from a first set of peripheral devices and output second data to a second set of peripheral devices. The system also includes a dialog engine in communication with the multimodal software application, wherein this dialog engine is configured to execute a workflow description received from the multimodal software application and provide the first data to the multimodal software application. Additionally, according to this aspect, the system includes a respective interface component associated with each peripheral device within the first and second sets; wherein each interface component is configured to provide the second data, if any, to the associated peripheral device and receive the first data, if any, from the associated peripheral device.

Another aspect of the present invention relates to a system for executing a multimodal software application that includes a dialog engine in communication with a) the multimodal software application, b) a first set of peripheral devices for receiving first data, and c) a second set of peripheral devices for outputting second data. According to this aspect, the dialog engine is configured to execute a workflow description received from the multimodal software application, wherein executing the workflow description includes generating the second data from the workflow description and providing the first data to the multimodal software application.

Yet another aspect of the present invention relates to a method for developing multimodal software applications. In accordance with this method, a portion of code is received implementing a first visual control within a screen of a graphical user interface. Next, a corresponding dialog unit, or workflow item, is generated based on the portion of code; and, ultimately, a link is created between the corresponding dialog unit and another dialog unit associated with a second visual control.

A further aspect of the present invention relates to a method for executing a multimodal software application having a graphical user interface with a screen. In accordance with this method, a workflow description is received corresponding to the screen, and the workflow description is executed in synchronization with the graphical user interface.

Still another aspect of the present invention relates to a system for developing a multimodal application. This system includes a code extractor configured to analyze a portion of code implementing a visual control within a screen of a graphical user interface, a dialog creator, in communication with the code extractor, configured to generate a workflow object based on the analysis of the portion of code; and a linker configured to generate a link to another workflow object, said link being a portion of the workflow object.

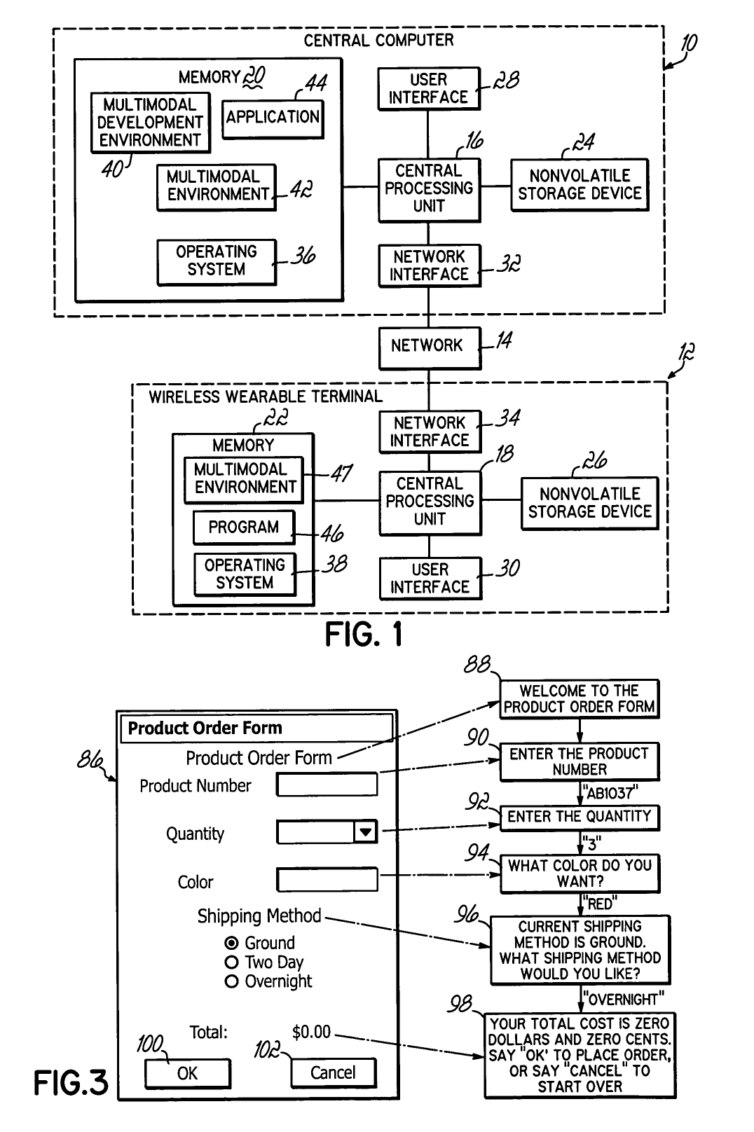

FIG. 1 illustrates an exemplary hardware and software environment suitable for implementing multimodal applications, such as voice-enabled ones, consistent with embodiments of the present invention. In particular, FIG. 1 illustrates a central computer 10 interfaced with a wireless wearable terminal 12 over a network, e.g., via an RF communications link, represented at 14. The invention contemplates that additional wireless wearable terminals 12 may be present without limitation. Although wireless wearable terminal 12 and network 14 are described as being “wireless” this designation is exemplary in nature and embodiments of the present invention are not limited to merely a wireless environment but can include conventional remote computers as well as conventional, wired network media and protocols. Similarly, embodiments of the present invention are described herein within the exemplary environment of an inventory or warehousing related system. This particular environment was selected, not to limit the applicability of the present invention, but to enable inclusion herein of concrete examples to aid in the explanation and understanding of the present invention.

Central computer 10 and wireless wearable terminal 12 each include a central processing unit (CPU) 16, 18 including one or more microprocessors coupled to a memory 20, 22, which may represent the random access memory (RAM) devices comprising the primary storage, as well as any supplemental levels of memory, e.g., cache memories, non-volatile or backup memories (e.g., programmable or flash memories), read-only memories, etc. In addition, each memory 20, 22 may be considered to include memory storage physically located elsewhere in central computer 10 and wireless wearable terminal 12, respectively, e.g., any cache memory in a processor in either of CPU's 16, 18, as well as any storage capacity used as a virtual memory, e.g., as stored on a non-volatile storage device 24, 26, or on another linked computer.

Central computer 10 and wireless wearable terminal 12 each receives a number of inputs and outputs for communicating information externally. Central computer 10 includes a user interface 28 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Wireless wearable terminal 12 includes a user interface 30 incorporating a display, such as an LCD display panel, an audio input device, such as a microphone, for receiving spoken information from the user and converting the spoken commands into audio signals, an audio output device, such as a speaker, for outputting spoken information as audio signals to the user, one or more additional user input devices including, for example, a keyboard, a touchscreen, and a digitizing writing surface, and/or a scanner, among others). The audio input and output devices are typically located in a headset worn by the user that affords hands-free operation of the wireless wearable terminal 12.

Central computer 10 and wireless wearable terminal 12 each will typically include one or more non-volatile mass storage devices 24, 26, e.g., a flash or other non-volatile solid state memory, a floppy or other removable disk drive, a hard disk drive, a direct access storage device (DASD), an optical drive (e.g., a CD drive, a DVD drive, etc.), and/or a tape drive, among others. Furthermore, central computer 10 and wireless wearable terminal 12 each include a network interface 32, 34, respectively, with a network 14 (e.g., a wireless RF communications network) to permit bidirectional communication of information between central computer 10 and wireless wearable terminal 12. It should be appreciated that central computer 10 and wireless wearable terminal 12 each include suitable analog and/or digital interfaces between CPU's 16, 18 and each of components 20-34, as understood by persons of ordinary skill in the art. Network interfaces 32, 34 each include a transceiver for communicating information between the central computer 10 and the wireless wearable terminal 12.

Central computer 10 and wireless wearable terminal 12 each operates under the control of a corresponding operating system 36, 38, and executes or otherwise relies upon various computer software applications, components, programs, objects, modules, data structures, etc. (e.g., a multimodal development environment 40, respective multimodal runtime environments 42 and 47, and an application 44 resident in central computer 10, a multimodal environment 47, and a program 46 resident in wireless wearable terminal 12). Each operating system 36, 38 represents the set of software which controls the computer system's operation and the allocation of resources. Moreover, various applications, components, programs, objects, modules, etc. may also execute on one or more processors in another computer coupled to either central computer 10 or wireless wearable terminal 12 via a network (not shown), e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, can be embodied as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

In accordance with the principles of the invention, a multimodal development environment 40, a multimodal runtime environment 42, and an application 44 constitute program codes resident in the memory 20 of central computer 10 and a program 46, as well as a multimodal environment 47, is resident in the memory 22 on the wireless wearable terminal 12. Central computer 10 may serve as a development computer executing the development environment 40 or the development environment 40 may execute on a separate development computer (not shown). Each may be a standalone tool or application, or may be integrated with other program code, e.g., to provide a suite of functions suitable for developing or executing multimodal software applications. The application 44, the multimodal environment 47, and program 46 are sets of software that perform a task desired by the user, making use of computer resources made available through the corresponding operating system 36, 38.

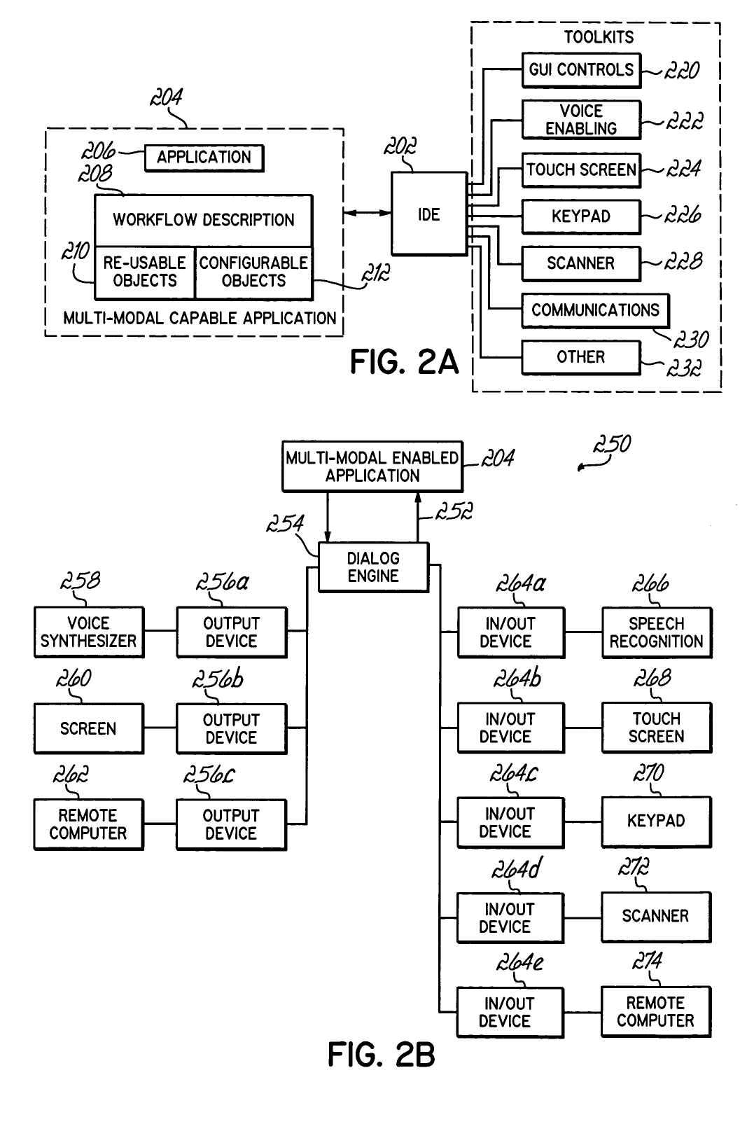

FIG. 2 depicts a development environment implemented according to exemplary embodiments of the present invention. The development environment 202 is used by a programmer to create a multi-modal software application 204. This multi-modal application 204 includes both application code 206 and a workflow description 208. As explained in more detail herein, the workflow description 208 can include configurable objects 210 and reusable objects 212. Additionally, the development environment 202 can include toolkits to simplify programming of different interface elements and different input and output devices.

Visual rapid development environments, or integrated development environments (IDEs) are currently popular aids in developing software applications, particularly the graphical user interface (GUI) for an application. Within these environments, a programmer builds a GUI screen by selecting and positioning a variety of GUI elements on the screen. These elements include objects such as radio buttons, text entry fields, drop-down boxes, title bars, etc. The IDE then automatically builds a code shell (e.g., C++ or Visual Basic) that implements each particular GUI object. The code shell is then customized and completed by the programmer to particularly specify the parameters of the GUI object and the related application execution logic. In this manner, IDEs permit rapid development of applications.

Embodiments of the present invention augment traditional IDEs by providing a development environment 202 in which applications 204 can be easily developed that can receive data from, and output data to, a wide variety of peripheral devices. For each screen of a GUI, the innovative integrated development environment 202 generates a workflow description 208 that specifies a “dialog” corresponding to that screen. To create the dialog, the development environment 202 identifies a dialog unit associated with each of the visual elements (e.g., text box, radio button, etc.) within the GUI screen and links the dialog units together; these dialog units are referred to as either workflow objects or workflow items when incorporated as part of a workflow description and these three terms are used interchangeably herein. Ultimately, a dialog, or workflow description, is generated for each GUI screen and contains all the dialog units, or workflow items, linked together such that the workflow description includes a series of different prompts, expected inputs to those different prompts, and a linking between the prompts that indicates a particular order.

Embodiments of the present invention can operate as a stand-alone development environment or can augment an existing IDE. In the second alternative, a programmer can develop an application 206 having GUI screens using a conventional environment, such as Microsoft Visual C++®. The resulting application 206 can then be modified in an augmented development environment that, for a GUI screen, generates dialog units based on the GUI screen's elements. These dialog units can then be linked so as to specify an order and, thus, a dialog or workflow description 208 is generated. Alternatively, a development environment can be implemented which includes all the functionality of traditional IDEs but, in addition, includes tools to generate dialog units (and the resulting workflow description 208) concurrent with the development of the GUI screens. According to this alternative, a single application is developed that includes a workflow description to support multiple modalities of inputting and outputting data for a given GUI screen.

Regardless of which alternative is implemented, during execution of the application 206 having GUI screens, the workflow descriptions 208 are executed as well. When a GUI screen is presented to a user; its corresponding workflow description is executed such that the appropriate dialog of data input and output is performed. By including within the workflow description 208 an identification of which peripheral devices can be involved in each input or output activity, the resulting dialog can easily utilize a variety of peripheral devices for inputting or outputting data. The execution of the application and the workflow description can occur at a central computer or at each remote computer. For example a wireless terminal may have limited processing capability barely sufficient to display GUI screens from the central computer. In this case, the workflow description and application are preferably executed on the central computer along with the necessary data communications between the two systems to implement the distributed application. Alternatively, the remote computer can have its own processing capability sufficient to execute both the application and the workflow description.

To facilitate the development of applications, the development environment 202 can include a variety of programmer's toolkits. For example, a GUI controls toolkit 220 can be used to readily implement the wide variety of visual objects that can be used to create a GUI screen. A typical toolkit would likely present the programmer with an indexed, or otherwise arranged, display of the available GUI controls. The programmer then navigates the arrangement of controls to locate a desired control, selects it and then imports the implementation of that control into the application being written.

Similarly, a toolkit 222 to voice enable GUI controls is provided that helps a programmer develop an application in which the GUI controls are voice-enabled as well. Its use is similar to the toolkit 220 already described. A programmer can identify a GUI control that is implemented in the application 206 and corresponding voice-enabling code from this toolkit 222 is exported to the development environment 202 to generate the workflow description 208. The use of the voice toolkit 222 can be accomplished by a programmer interactively as well as accomplished by an automatic preprocessor of the development environment 202 that can parse the application 206, recognize the GUI control, search the voice toolkit 222 for the corresponding control, and then generate a corresponding portion of the workflow description.

In addition to these toolkits, separate toolkits can be provided for different input and output devices. Through the use of toolkits, support components for interfacing with particular devices can be pre-programmed and re-used in different applications without the need to create them each time. For example, a scanner toolkit can include device specific information for a multitude of different scanners and the programmer would select only those components which would likely be in the environment expected to be encountered at run time. Exemplary toolkits would include a touch screen toolkit 224, a keypad toolkit 226, a scanner toolkit 228, a communications toolkit (e.g., to provide networked communication components) 230, and other toolkits 232. The use of toolkits allows the programmer to select only those components which are needed for a particular application. As a result, the application's size and efficiency are improved because extraneous, unused code is not present.

The IDE 202 has been described, so far, only in relation to a visual, or graphical, user interface. However, exemplary embodiments of the present invention can be utilized to convert other monomodal user interfaces into multimodal applications. For instance voice response interfaces are well known in the telephone industry and specify a series of voice prompts that respond to different audio responses. An exemplary IDE, therefore, can analyze the software application that specifies each voice prompt and generate a corresponding workflow object and workflow order. This new workflow object is not limited to just voice prompts but could include a GUI screen control and other prompts for various peripheral devices. Accordingly, applications with user interfaces other than GUI screens can also be converted into multimodal applications according to embodiments of the present invention.

With respect to FIG. 3, an exemplary GUI screen 86 is depicted. This screen can be considered a hierarchical arrangement of objects and features such as:
Object: screen
   Feature: Screen Header Text: “Product Order Form”
   Feature: Ordered list of screen elements
      Object: Static Text: “Product Order Form”
      Object: Static Text: “Product Number”
      Object: Text Entry:
      Object: Static Text: “Quantity”
      Object: Drop Down Box:
         Feature: (ordinal list, for example 0 . . . 20)
      Object: Static Text: “Color”
      Object: Drop Down Box:
         Feature: (list of available colors)
      Object: Static Text: “Shipping Method”
      Object Button Group
         Feature: limit of one button in group allowed
         Feature: Button 1 text “Ground”
         Feature: Button 2 text “Two Day”
         Feature: Button 3 text “Overnight”)
         Feature: default button: button 1
      Object: Variable Text: “Total: $0.00”
      Object: Button “Okay”
      Object: Button “Cancel”

Within the development environment 202, the code implementing the visual elements of screen 86 can be used to generate dialog units to make a workflow description. For example, to voice-enable the GUI screen 86, a workflow description of various dialog units would be generated that, in addition to the customary GUI, specifies audio output is to be supplied to a headset, for example, and also specifies that input could be received as voice data via a microphone. Thus, the workflow description, or dialog, would include an audio prompt when input is needed and would wait for voice or other data to be received until providing the next prompt. Based on the order of the GUI screen elements or other application logic, the dialog units can be linked in a particular order to mimic the order of the GUI screen 86. The following description continues this specific example of a voice-enabled application. However, other or additional input and output modes could be supported as well.

An exemplary dialog (elements 88 through 98) is depicted along the right of FIG. 3. When the GUI screen 86 is displayed on a screen, for example that of mobile computer 12, the workflow description associated with the screen 86 is executed. The result is the illustrated dialog. A series of prompts are produced (88 through 98) and after each prompt the dialog waits for the input from the user (shown as quoted text).

Thus, a welcome prompt 88 is output as audio data and the user is prompted with an instruction 90 to enter a product number. The user can then input the product number (e.g., AB1037) via the keyboard or other input device on the mobile computer 12, or can speak the product number. In response, the next prompt 92 is generated and this sequence is repeated until interaction with the GUI screen 86 is completed. Accordingly, while the application is executing, there is a current screen (e.g., screen 86) and a current field (e.g, Quantity) and synchronized with this current field and screen, is an associated dialog unit.

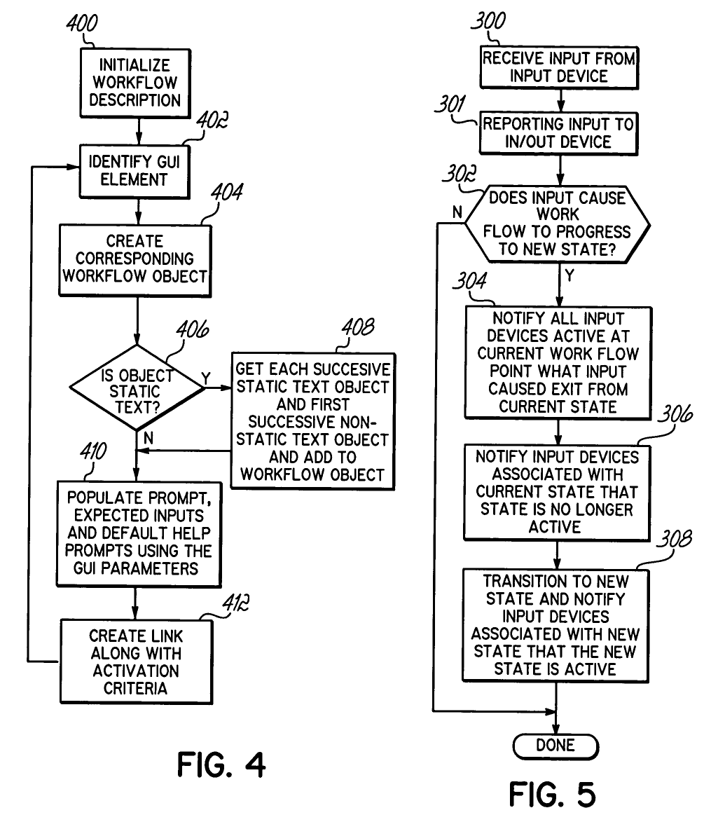

FIG. 4 illustrates a flowchart detailing an exemplary method for creating a workflow description from the code implementing a GUI screen in accordance with embodiments of the present invention. The GUI screen 86 described above is used as an example during explanation of this method. Processing of the GUI screen objects in this manner is accomplished by the development environment either automatically or in an interactive session involving the programmer. At step 400 a workflow description is initialized that corresponds to the “Product Order Form” screen.

The first GUI element encountered, or identified (step 402), in the screen 86 is the screen header text “Product Order Form”. The processor recognizes this as a text field that names a screen and can identify its value as well. As a result, a workflow object, or dialog unit, is created in step 404 that corresponds to this GUI screen element. In particular, a dialog unit can be generated that includes the phrase “Welcome to the ______ screen” where the blank is filled in with the value (i.e., Product Order Form) that was extracted from the GUI screen element.

Thus, the parameters of the workflow object can be populated, in step 410, from the specific fields and values of the corresponding GUI elements. Of course, the workflow objects are configurable so that a programmer can modify the default-generated objects if more, less or different information is desired to be included in the workflow object. In a preferred embodiment, static text objects, which are relatively uncomplicated screen elements, are treated efficiently in steps 406 and 408, by combining successively arranged static text objects until the first non-static text object is encountered. As a result, the non-static text object and all the static text objects are combined into one workflow object, in step 408.

A link is then created, in step 412, linking the workflow object to a successor workflow object. By default, the link is created to the workflow object corresponding to the next visual element from the GUI screen. Additionally, the default activation condition of the link, i.e., when is the link followed, is defined to be when input is received. However, different link activation conditions can be used; for example, the value of the input can be tested to determine one of multiple links to follow. As another example, the other input fields of the screen can be tested and one link followed if all required input fields are filled and another link can be followed if some fields are missing data. Alternatively, the activation criteria may be related to timing such that the next link is automatically followed after x seconds have elapsed. Additionally, the activation criteria can be logic embedded in the application 204 such that the dialog engine 254 communicates data to the application 204 that determines how to proceed and then instructs the dialog engine 254 which workflow object to link to next. The breadth and variety of techniques available to programmers for defining conditions and specifying their respective results are available within embodiments of the present invention for defining links between workflow objects.

Next the sequence repeats until a workflow object is created for each GUI element. The collection of workflow objects is called a workflow description, or dialog, and corresponds to the GUI screen. While the different permutations and combinations of GUI controls and their particular features provides endless possibilities of different dialogs that can be generated, the flowchart of FIG. 4 details a general method that can used for any GUI screen. However, some specific GUI elements and workflow objects are described below to illustrate exemplary applications of the method of FIG. 4

In the GUI screen 86 of FIG. 3, the “Color” element is a drop-down box with a set of expected inputs, e.g., “red”, “blue” and “white”. When the corresponding workflow object is created, these expected inputs can be used as a default help prompt. For example, the processing of the “Color” element will generate a corresponding voice dialog that inquires “What color do you want?” If the user responds “help”, then an additional prompt can be created that says, for example, “Available colors are red, blue and white.” As before, the programmer can reconfigure the default help prompt if, for some reason, it is not appropriate in a given situation. The workflow object can also include code that tests whether the received input from the user is one of the permitted responses or if the user must be prompted to retry the input.

In general, as each GUI element is analyzed, the appropriate prompt, set of possible inputs, and default help features of the corresponding workflow object are filled in. Typically, the static text will become the prompt (in this case, audio output) for the workflow object; item lists, or button names, become the expected input; and the list of item names or button names are used as a default help prompt.

Within the screen 86, the “OK” button 100 and the “Cancel” button 102 can be activated at anytime even if the input focus is on another field at the time. Thus, the workflow description generated for a GUI screen, such as screen 86, can designate some dialog units as “global” elements such that any input received from a user must be evaluated to determine if it relates to one of these global elements. When the dialog is executed, therefore, even though a particular field of a particular screen may currently have input focus, the workflow description provides the capability that the response from the user can engage one of the global elements instead. Another example of a global element would be the labels associated with the input fields on the visual interface. For example, the screen 86 has fields such as “Product Number”, “Quantity”, “Color”, etc. and a user could switch focus to any of these global elements by simply speaking, or otherwise specifying via an input device, that particular label. In response, any received input would be associated with that field.

The development environment 202 also permits basic dialog units and links to be grouped together to form larger reusable objects. Typically, the reusable objects are used to encapsulate some segment of a work flow description that will be performed in multiple parts of the application 206. Examples of this might include a dialog unit that is responsible for obtaining date/time information from the user or to query a remote database for a specific piece of information. Instead of repeating the development process each time the code implementing this activity is encountered, the programmer can retrieve the reusable object from storage. While the specific link to and from each instantiation of the reusable object will be different, the internal dialog units and respective links will remain the same.

As described, the workflow description 208 includes a series of messages to output to a user and includes a number of instances where input is expected to be received. This information remains the same regardless of what peripheral devices are connected to a computer executing the workflow description. Thus, the workflow description can be utilized to provide input and output in many different modalities such as speech, audio, scanners, keyboards, touch screens. However, some output is not appropriate for some peripheral devices and some input is not going to be provided by certain input devices. Accordingly, each dialog unit, or workflow object, within the workflow description can include a designation of which peripheral devices are to be used with respect to that dialog unit. For example, the workflow description may reflect that a prompt for “What quantity?” is to be output as a screen prompt (e.g., a drop down box) and as an audio output. However, the workflow description might reflect that input for that prompt may be received from the screen, as a voice response, or via a bar code scanner. Any specific implementation code to support a particular peripheral device can be retrieved from an appropriate toolkit during generation of the workflow description. In addition to explicitly specifying input and output devices as just described, the workflow description can omit such references so that when it is executed all peripheral devices, or a set of predetermined default peripheral devices, are used.

Once a workflow description has been generated, it can be executed along with the application 204 so as to provide multi-modal input and output. An exemplary runtime environment 250 is depicted in FIG. 2B. Although a number of peripheral devices are illustrated, one or more of these devices can be omitted without departing from the scope of the present invention. Within this environment, a multi-modal software application 204 executes with the assistance of a dialog engine 254. For example, a voice enabled application would be able to provide a user with not only a graphical user interface but a voice user interface as well. The dialog engine 254 and software application can operate on the same computer or separate computers. Additionally, they can operate on a remote computer or on a central computer.

In practice, the application 204 provides a workflow description 208 to the dialog engine 254 which executes that workflow description 208 and returns data 252 to the application 204. To one of ordinary skill, it would be apparent that the application 204 does not necessarily have to provide the entire workflow description 208 but can simply provide references to where the workflow description 208 or pertinent portions thereof are stored. The dialog engine 254 controls the execution of the workflow description 208 and manages the interface with the peripheral devices. These peripheral devices can include a voice synthesizer 258 for providing audio output; a display screen 260 for depicting a GUI; a remote computer 262, 274 from which data can be retrieved or to which data can be sent; a speech recognition system 266 for capturing voice data and converting it into appropriate digital input; a touchscreen 268 for inputting and outputting data; a keypad or keyboard 270; and a scanner 272 such as a bar code scanner or an RFID tag scanner. Of course, other peripheral devices such as a mouse, trackball, joystick, printer and others can be included as well.

One exemplary method of interfacing with the peripheral devices includes the use of software components 256a-c and 264a-264e that interface between the dialog engine 254 and respective device drivers for a peripheral device. In this manner the dialog engine 254 is not device dependent and adding support for a new device simply requires the generation of an appropriate interface component. In operation, the software component 256a-c and 264a-e can, for example, receive a data value from the dialog engine 254 to output to its associated peripheral device and b) receive a workflow object prompt from the dialog engine which is relayed to the user via the associated peripheral device. In addition, in/out devices 264a-e can also forward data to the dialog engine 254 received at its associated peripheral device.

When the application 204 is executing so as to display a particular GUI screen, the corresponding workflow description 208 is being executed by the dialog engine 254. The dialog engine 254 retrieves the first dialog unit, or workflow object, and sends its output to the appropriate peripheral devices. For example, a string of text for display on the screen 260 may also be converted to a voice prompt by voice synthesizer 258. The dialog engine 254 knows which output components, or devices, 256a-c and in/out devices 264a-e to instruct to output the data because the workflow description can include this information as specified by the programmer.

In response to the prompt, when a software component 264a-e determines input is received via its associated peripheral device, this input is converted into a format useful to the dialog engine 254 and forwarded to the dialog engine 254. For example, a voice response may be provided by the user to the speech recognition system 266. This speech data is converted into digital representations which are analyzed to recognize the spoken words and typically converted into ASCII representations of the speech data. In some instances there is an expected set of input values and the ASCII data can be compared to this set to determine which member of the set was received as input. In other instances, the ASCII data is simply forwarded to the dialog engine 254.

Once the dialog engine 254 receives the input, the engine 254 determines how to continue executing the workflow description 208. The input may not be valid and the dialog engine 254 may need to re-send the current prompt, possibly the help prompt, as output. The mere receipt of input may cause the dialog engine 254 to move to the linked, successor workflow object or, alternatively, the input data can be analyzed by the dialog engine 254 to determine which of a plurality of possible links should be followed. In addition, the dialog engine 254 passes the data 252 to the application 204 so that the application specific logic (e.g., updating an inventory system) can be accomplished.

This sequence repeats itself when the new workflow object is retrieved and executed. When the dialog for the current screen is finished, the application 204 will likely retrieve a different GUI screen and the entire process can repeat itself with a new workflow description corresponding to the new GUI screen. Alternatively, the entire workflow description 208 can relate to a multi-screen application so that one workflow object does not merely link to another workflow object in the current screen but can even link to different screens all of which are included in the workflow description. Embodiments of the present invention are operable with applications that are designed either way.

In various embodiments of the present invention, data which is input can be provided not only to the dialog engine 254 but to the other peripheral devices as well. FIG. 5 provides an exemplary operation of the dialog engine 254 that is more detailed than the overall description provided above. The flowchart of FIG. 5 assumes that a prompt has been output to appropriate peripheral devices and the dialog engine 254 is waiting to receive input in response to that prompt.

An in/out device software component 264a-e, implicated by the current workflow object, detects that input has been received at its associated peripheral device and signals the dialog engine. One of ordinary skill would appreciate that either polling-based or interrupt-driven mechanisms can be used by the dialog engine and the in/out devices, or software components 264a-e, to determine input is available. In step 300, the dialog engine receives the input. At this point, the dialog engine 254 can forward, in step 301, the received input to some or all of the output devices 256a-c and in/out devices 264a-e.

Next, in step 302, the dialog engine determines, based on the link activation criteria for the current workflow object, whether the input should cause the dialog engine to progress to a successor workflow object. If not, then the processing of the received input is complete.

If the workflow should progress, however, a number of steps can be performed. In step 304, the dialog engine notifies each of the active input software components 264a-e of the input which was received. These devices can then elect to have their associated peripheral device “display” the input value that was received via some other peripheral device. For example, the “Color” field on the display screen 86 can be updated with the text “Red” even though the user spoke the answer instead of typing it in (or selecting it with a mouse click). Any output devices 256a-c specified in the workflow description can be provided the input value as well so that their displays can be updated.

In step 306 the dialog engine instructs the input devices 264a-e that the current state, or workflow object, is no longer active and, in response, these components can stop waiting for data to be received at their respective peripheral device.

The dialog engine then retrieves the next workflow object which produces a prompt being output from the output devices 256a-c. The dialog engine can then instruct, in step 308, those input devices 264a-e active for the new workflow object to start watching for input data.

Although the above process was described as a number of individual, sequential steps, embodiments of the present invention contemplate utilizing the entire or at least significant portions of the workflow description when processing input and data. For example, the workflow description provides the dialog engine 254 with information about the grammar and contents of the GUI interface. With this information, the dialog engine can investigate any input to see whether it relates to global items such as the “OK” button 100 or “Cancel” button 102 even though these items may not currently have input focus. Similarly, a peripheral device can be used to input more than one data at a time. For example, the location of a part in a warehouse may include a row number (an integer), a shelf identifier (a 4 letter variable), and a bin location (another integer). When a worker picks a part from this location they may be prompted for all three pieces of information which would require 3 separate workflow objects resulting in three separate prompts. However, the bin may include a bar code label which the worker can scan to easily input all three pieces of data at the same time. Thus, in operation, the dialog engine generates a prompt similar to “Please identify row location?”. In response, the in/out device 264d for the scanner 272 recognizes that three pieces of information are received from the scanner. The in/out device 264d can then inform the dialog engine 254 that three data are being provided and the values for these data. Because the dialog engine 254 has the linking information from workflow description available, the dialog engine 254 can associate the data with the current prompt and the next two prompts and update any devices 256a-c, 264a-e to reflect all the received data. In addition, the dialog engine can skip over any prompts for data already received and proceed with the next workflow object for which data has not been received.

Thus, while the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

For example, a detailed description of the exemplary operational environment involving wireless terminals has been set forth. However, embodiments of the present invention also contemplate computers connected via wired network media such as a LAN or even over the Internet or other WAN. Also, the processing capability of the remote terminals can vary and include dumb terminals, thin clients, workstations and server-class computers. Similarly, the dialog engine and GUI application can be utilized on a stand-alone computer that has no network capability.

1. A system for executing a multimodal software application, comprising:
the multimodal software application, wherein said multimodal software application is configured to receive first data input from a first set of peripheral devices and output second data to a second set of peripheral devices;
a dialog engine in communication with the multimodal software application, wherein said dialog engine is configured to execute a workflow description related to the multimodal software application and provide the first data to the multimodal software application; and
a respective interface component associated with each peripheral device within said first and second sets; wherein each interface component is configured to provide the second data, if any, to the associated peripheral device and receive the first data, if any, from the associated peripheral device.

2. The system according to claim 1, wherein a peripheral device can be a member of both the first and second sets.

3. The system according to claim 1, wherein the first set of peripheral devices includes a speech synthesizer and the second set of peripheral devices includes a speech recognizer.

4. The system according to claim 1, wherein the multimodal software application further comprises a graphical user interface including a screen.

5. The system according to claim 4, wherein the workflow description comprises a set of workflow objects, wherein each workflow object is associated with a respective visual control within said screen.

6. The system according to claim 5, wherein each workflow object further comprises:
a prompt related to the associated visual control; and
a link to another workflow object.

7. The system according to claim 6, wherein each workflow object further comprises:
a plurality of expected input values; and
a help message.

8. The system according to claim 6, wherein each workflow object further comprises:
a first identification of members of the first set from which first data can be received; and a second indication of members of the second set to which second data can be sent.

9. The system according to claim 6, wherein the prompt is the second data.

10. The system according to claim 1, wherein the dialog engine is further configured to redirect the first data to a third set of peripheral devices comprising selected members from the first and second set.

11. The system according to claim 6, wherein each workflow object further comprises:
a plurality of links, each link being to a different respective workflow object and each of the plurality of links having an activation criterion.

12. The system according to claim 11, wherein the activation criterion relates to a value of the first data.

13. The system according to claim 6, wherein the dialog engine is further configured to:
execute a particular workflow object by outputting the prompt as the second data;
instruct each interface component associated with a respective member of the first set to wait for the first data;
based on the first data determine whether to follow the link; and
execute said another workflow object.

14. The system according to claim 6, wherein the dialog engine is further configured to:
receive the first data; and
forward the first data to each interface component associated with a respective member of the second set.

15. The system of claim 4, wherein the execution of the workflow description is synchronized to a display, by the dialog engine, of the graphical user interface.

16. A system for executing a multimodal software application comprising:
a dialog engine in communication with a) the multimodal software application, b) a first set of peripheral devices for receiving first data, and c) a second set of peripheral devices for outputting second data; and
said dialog engine configured to execute a workflow description related to the multimodal software application, wherein executing the workflow description includes generating the second data from the workflow description and providing the first data to the multimodal software application.

17. The system according to claim 16, wherein the first set of peripheral devices includes a speech synthesizer and the second set of peripheral devices includes a speech recognizer.

18. The system according to claim 16, wherein the dialog engine is configured to communicate with each of the peripheral devices in the first and second sets via a respective interface component associated with each peripheral device within said first and second set; wherein the interface component is configured to provide the second data, if any, to the associated peripheral device and receive the first data, if any, from the associated peripheral device.

19. The system according to claim 16, wherein the multimodal software application further comprises a graphical user interface including a screen.

20. The system according to claim 19, wherein the workflow description comprises a set of workflow objects, wherein each workflow object is associated with a respective visual control within said screen.

21. The system according to claim 20, wherein each workflow object further comprises:
a prompt related to the associated visual control; and
a link to another workflow object.

22. The system according to claim 21, wherein the dialog engine further comprises:
an execution unit configured to execute a particular workflow object;
a prompt generator configured to output the prompt as the second data;
a data tester configured to determine if the first data received in response to the second data satisfies a set of criteria associated with the link; and
an object loader configured to load the another workflow object in the execution unit when instructed by said data tester.

23. A method for developing multimodal software applications, said method comprises the steps of:
a) receiving a portion of code implementing a first visual control within a screen of a graphical user interface;
b) generating a corresponding dialog unit based on the portion of code; and
c) creating a link between the corresponding dialog unit and another dialog unit associated with a second visual control within the screen.

24. The method according to claim 23, wherein the step of generating the corresponding dialog unit includes the steps of:
extracting an expected set of inputs from the portion of code to populate the dialog unit.

25. The method according to claim 23, wherein the step of generating the corresponding dialog unit includes the steps of:
extracting a default prompt from the portion of code to populate the dialog unit.

26. The method according to claim 23, wherein the step of generating the corresponding dialog unit includes the step of:
extracting a default help prompt from the portion of code to populate the dialog unit.

27. The method according to claim 24, further comprising the step of:
creating a default help prompt based on the expected set of inputs.

28. The method according to claim 23, further comprising the steps of:
receiving modification input for the dialog unit; and
modifying the dialog unit in accordance with the input.

29. The method according to claim 23, wherein the dialog unit comprises:
a prompt for outputting to one or more peripheral devices;
the link.

30. The method according to claim 29, wherein the dialog unit further comprises:
a first identification of the one or more peripheral devices; and
a second identification of a set of peripheral devices from which to receive first data in response to the prompt.

31. The method according to claim 23, further comprising the steps of:
repeating the steps a) through c) for a plurality of visual control elements within the screen; and
combining the resulting plurality of dialog units and links into a workflow description corresponding to the screen.

32. The method according to claim 23, further comprising the steps of:
identifying a set of previously generated dialog units and previously created links; and
storing the set as a reusable object.

33. The method according to claim 32, further comprising the step of:
retrieving the reusable object to generate the corresponding dialog unit.

34. A method for executing a multimodal software application having a graphical user interface with a screen, the method comprising the steps of:
receiving a workflow description corresponding to the screen, and
executing the workflow description in synchronization with the graphical user interface.

35. The method according to claim 34, wherein the step of executing includes the steps of:
identifying a workflow object associated with a visual control on the screen;
executing the workflow object; and
identifying another workflow object linked to the workflow object.

36. The method according to claim 35, wherein the step of executing the workflow object includes the steps of:
extracting a prompt from the workflow object;
sending the prompt to a first set of peripheral devices;
instructing a second set of peripheral devices to wait for a response; and
forwarding the response to the multimodal software application.

37. The method according to claim 36, further comprising the step of:
forwarding the response to one or more of the peripheral devices of the first and second sets.

38. The method according to claim 36, further comprising the steps of:
extracting a default help prompt from the workflow object; and
sending the default help prompt to one or more of the peripheral devices of the first and second sets.

39. The method according to claim 34, wherein the step of executing includes the steps of:
outputting audio prompts corresponding to the screen; and
receiving input via speech recognition system in response to the audio prompts.

40. The method according to claim 36, further comprising the steps of:
extracting information regarding peripheral device membership in the first and second sets from the workflow object.

41. The method according to claim 36, wherein the response also includes data related to the another workflow object.

42. A system for developing a multimodal application comprising:
a code extractor configured to analyze a portion of code implementing a visual control within a screen of a graphical user interface;
a dialog creator, in communication with the code extractor, configured to generate a workflow object based on the analysis of the portion of code; and
a linker configured to generate a link to another workflow object, said link being a portion of the workflow object.

43. The system according to claim 42, wherein the code extractor is further configured to populate a prompt based on parameters of the visual control.

44. The system according to claim 43, wherein the code extractor is further configured to:
identify a set of expected inputs, if any, to the prompt; and
identify a default help prompt.

45. The system according to claim 42 further comprising:
a library of predefined workflow objects, each relating to a plurality of visual controls within said graphical user interface; and
an object retriever configured to preempt the dialog creator and generate the workflow object by extracting one of the predefined workflow objects from the library.

46. The system according to claim 42, wherein the dialog creator further comprises:
an editor configured to receive input and modify the workflow object in accordance with the input.

47. The system according to claim 42, further comprising:
a controller configured to manage the operation of the code extractor, the dialog generator, and the linker with respect to each visual control on the screen so as to generate a corresponding workflow object for each visual control; and
a workflow creator configured to combine the workflow objects into a workflow description.

48. A computer-readable medium bearing instructions for executing a multimodal software application having a graphical user interface with a screen, said instructions being arranged, upon execution thereof, to cause one or more processors to perform the steps of:
receiving a workflow description corresponding to the screen, and
executing the workflow description in synchronization with the graphical user interface.

49. A computer-readable medium bearing instructions for developing multimodal software applications, said instructions being arranged, upon execution thereof, to cause one or more processors to perform the steps of:
receiving a portion of code implementing a first visual control within a screen of a graphical user interface;
generating a corresponding dialog unit based on the portion of code; and
creating a link between the corresponding dialog unit and another dialog unit associated with a second visual control within the screen.
